(19) United States
(12) Patent Application Publication
(10) Pub. No.: US 2013/0120144 A1
(43) Pub. Date: May 16, 2013

(54) PORTABLE ALARM DEVICE

(71) Applicants: Dunstan Walter Runciman, Cape Town (ZA); David Denoon-Stevens, Cape Town (ZA)

(72) Inventors: Dunstan Walter Runciman, Cape Town (ZA); David Denoon-Stevens, Cape Town (ZA)

(73) Assignee: MY GUARD SECURITY CLOSE CORPORATION, Cape Town (ZA)

(21) Appl. No.: 13/810,037

(22) PCT Filed: Jul. 12, 2011
(86) PCT No.: PCT/IB2011/053104

§ 371 Date: Jan. 14, 2013

(30) Foreign Application Priority Data
Jul. 12, 2010 (ZA) 2010/04884

(51) Int. Cl. G08B 13/24

(52) U.S. Cl. CPC G08B 13/24
USPC 340/571

(57) ABSTRACT

A portable alarm device which includes a casing containing one or more of the following; means for detecting that the device has been moved, means for detecting a person in the vicinity of the device and means for detecting changes in ambient light level. The device further includes a scrolling system which makes each of said means available in turn for receiving commands that are inputted manually. The device has a code accepting unit which receives an inputted code to bring the device to a condition in which a selected one of said means can be activated. The device is deactivated by insertion of said code for a second time. By providing the device with a sound generator and a sound receiver it is possible to interconnect the devices so that activating or deactivating one is used to activate or deactivate a series. Likewise the establishment of an alarm condition at one device can be used to trigger alarm conditions at other devices.

### FIELD OF THE INVENTION

THIS INVENTION relates to a portable alarm device.

### BACKGROUND TO THE INVENTION

With the increase in crime levels it is necessary for householders and travelers to take more care of their belongings. House breakings and burglaries are common as are opportunistic thefts of luggage and other articles such as cameras and laptop computers whilst they are not being watched by the owner during a journey.

The present invention provides a portable alarm device that can be used either to protect a space, to protect a high value article, to protect a person, to protect a vehicle against unauthorised opening or to detect unauthorised opening of a suitcase or other item of luggage, a laptop bag etc.

### BRIEF DESCRIPTION OF THE INVENTION

According to the present invention there is provided a portable device including means for arming and disarming the device and means sensitive to movement of a person in the vicinity of the alarm device and/or means sensitive to movement of the portable alarm itself and/or means sensitive to tapping of the alarm device and/or means sensitive to changes in the ambient lighting level to which the alarm device is subjected.

The portable alarm device can include means which emit sound, or means which emit light, or means which emit both sound and light, when an alarm condition is established.

A sound receiver can be provided for receiving a sound signal from another such device thereby to establish an alarm condition in said device whereby a series of two or more alarm devices can be triggered upon an alarm condition being established by one such device.

The device can also include a manually operated switch for putting the device into sleep mode, bringing it out of sleep mode and acting as a panic button.

In a further form there is a switch and means for detecting a sequence of manual operations of said switch thereby to permit an arming code to be stored, which code, when re-entered, disarms the device. In this form there can be scrolling means for permitting commands to be given to the different functions of the device in turn, and a plurality of light sources each of which when illuminated indicates that access to a specific function of the device is available at that time. Preferably there are means for detecting changes in ambient lighting level, means for detecting movement of a person in the vicinity of the device, and means for detecting movement of the device itself, these functions being accessible in sequence for the purpose of giving commands.

In a specific construction, when a specific one of said light sources is illuminated and said switch is operated, the means for emitting light or the means for emitting sound, or both such means, are activated thereby to provide a panic alarm

The device can include means sensitive to an impact, means for detecting operation of said switch and for detecting an impact in succession and means activating said means for emitting sound or the means for emitting light or both such means upon such succession being detected.

Means for transmitting a sound signal upon the device entering its activated state can be provided, and there can be means for receiving such a sound signal from another device, reception of which signal places the device in its activated state.

### BRIEF DESCRIPTION OF THE DRAWINGS

For a better understanding of the present invention, and to show how the same may be carried into effect, reference will now be made, by way of example, to the accompanying drawings in which:—

FIG. 1 is a pictorial view of an alarm device according to the present invention from the front and from one end;

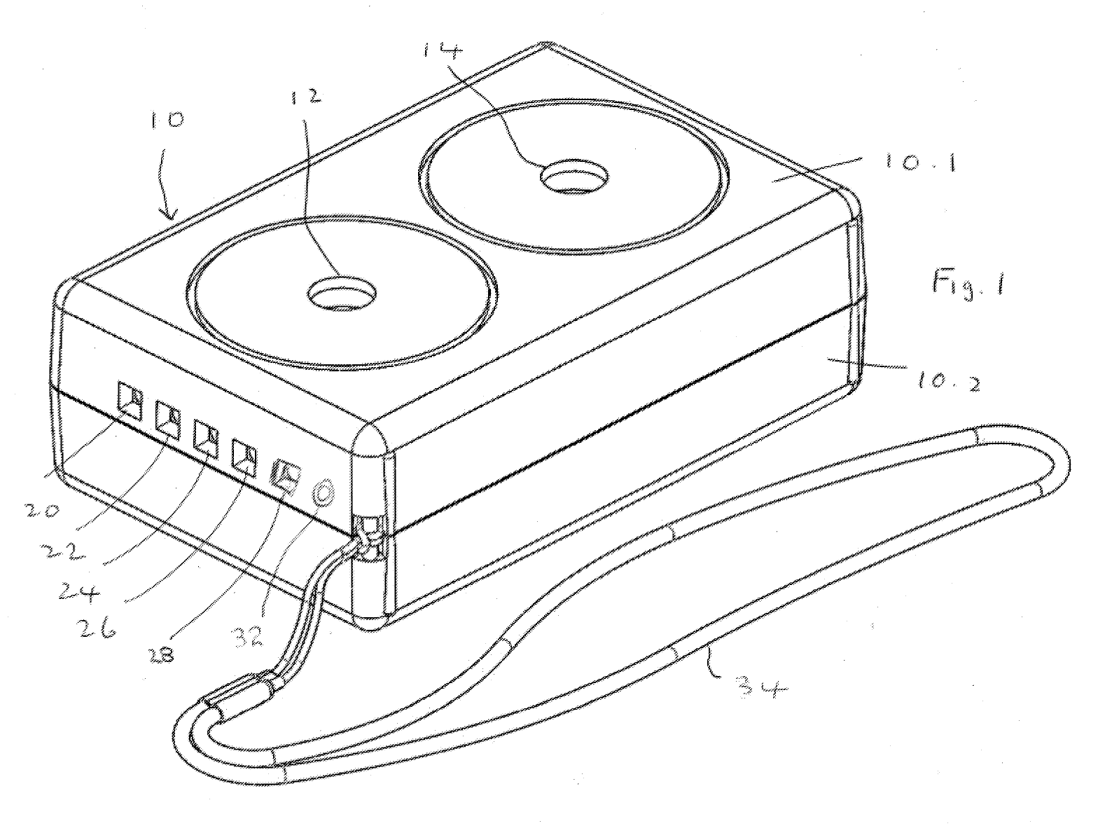

FIG. 2 is a pictorial view of the alarm device from the opposite end;

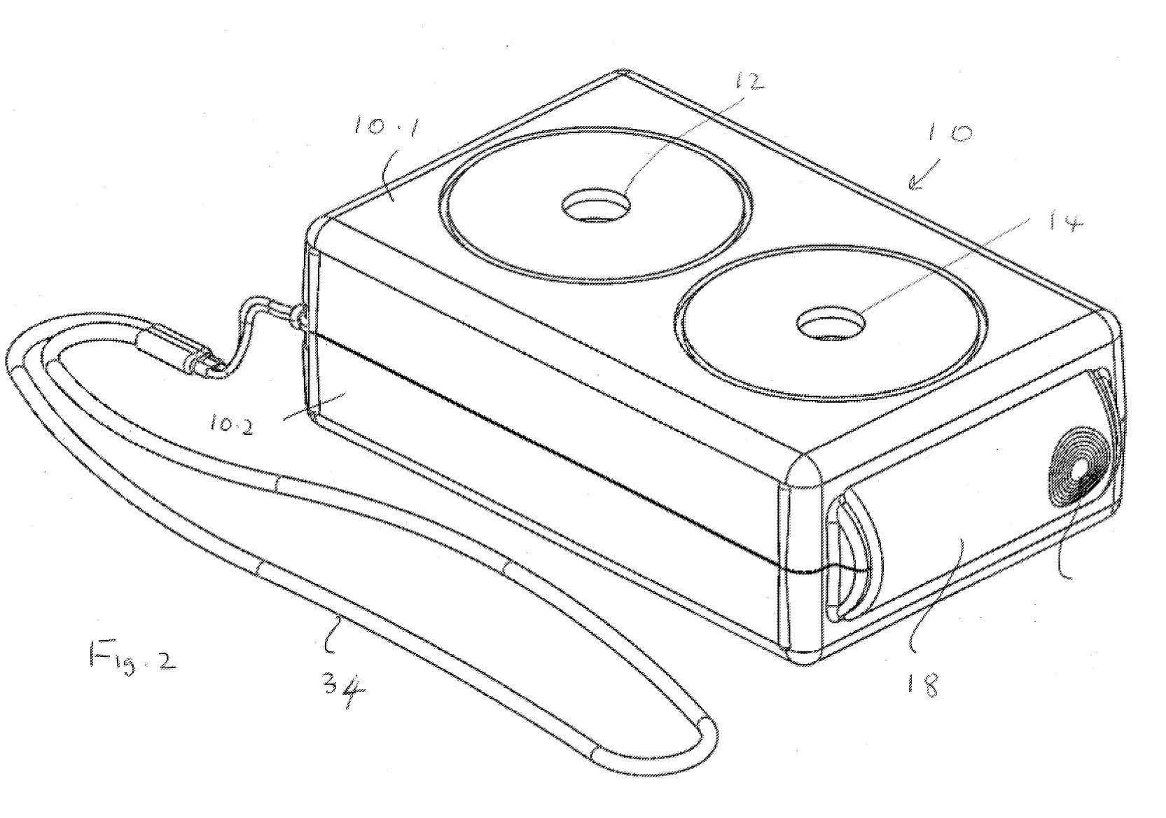

FIG. 3 is a pictorial view of the alarm device from the rear;

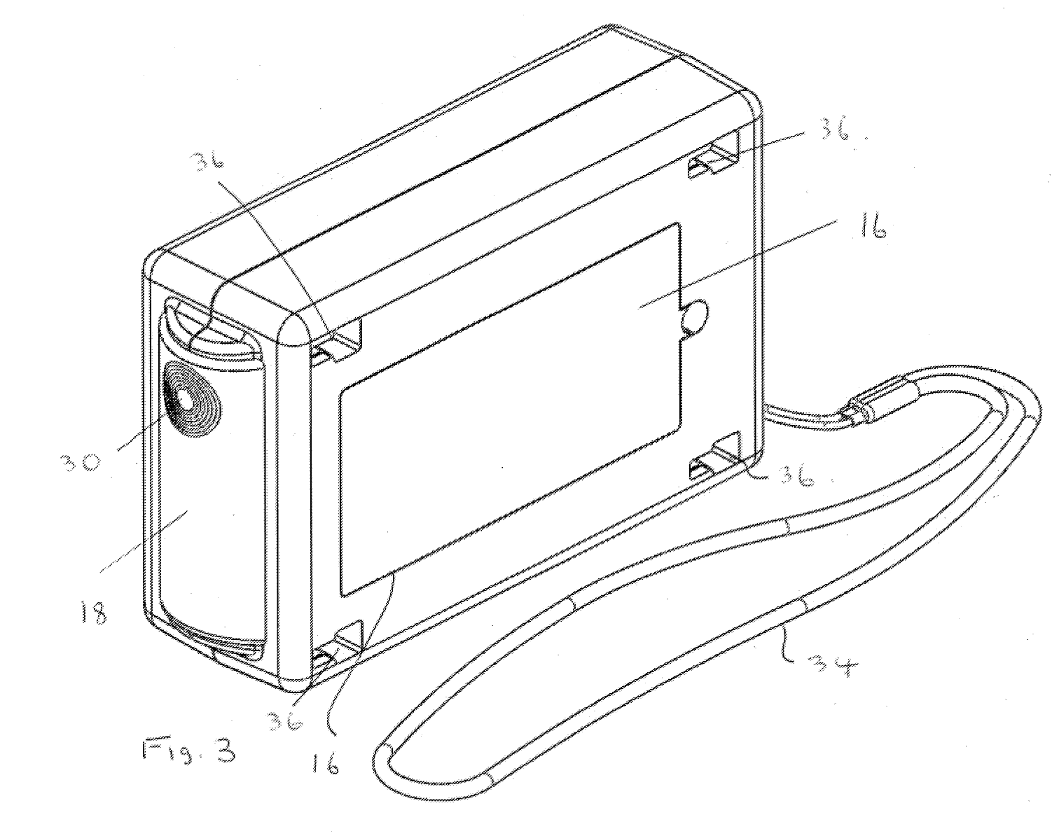

FIG. 4 is a pictorial view of the rear of the alarm device from the opposite end; and

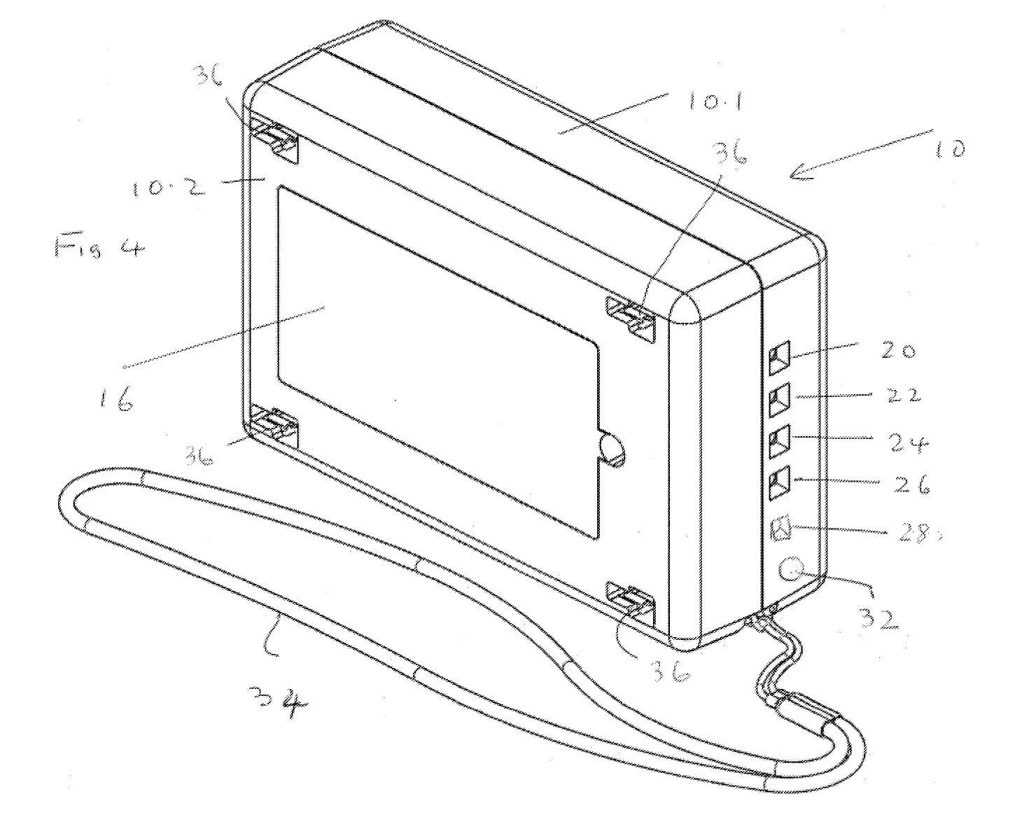

FIG. 5 diagrammatically illustrates the operating features of the alarm.

### DETAILED DESCRIPTION OF THE DRAWINGS

The alarm device illustrated comprises a casing designated 10 which consists of two parts 10.1 and 10.2 which snap fit together and cannot thereafter readily be separated.

Two high power piezo sounders are provided, the sound from these emerging through the holes designated 12 and 14 in the drawings.

The main wall of the casing part 10.2 has a removable cover 16 mounted thereon, this closing a battery compartment.

A lens 18, preferably of the Fresnel type, is mounted on one end of the casing 10 and at the other end of the casing 10 there is a row of LEDS 20, 22, 24, 26 and 28 which, as will be described, indicate the status of the device. Behind the main part of lens 18 there is a passive infrared detector. A light emitting diode, or a group of two or more light emitting deodes, is located behind the part of the lens 18 which is designated 30. A switch is shown at 32 and a carrying strap at 34. The switch 32 can be of any suitable type such as a push button switch.

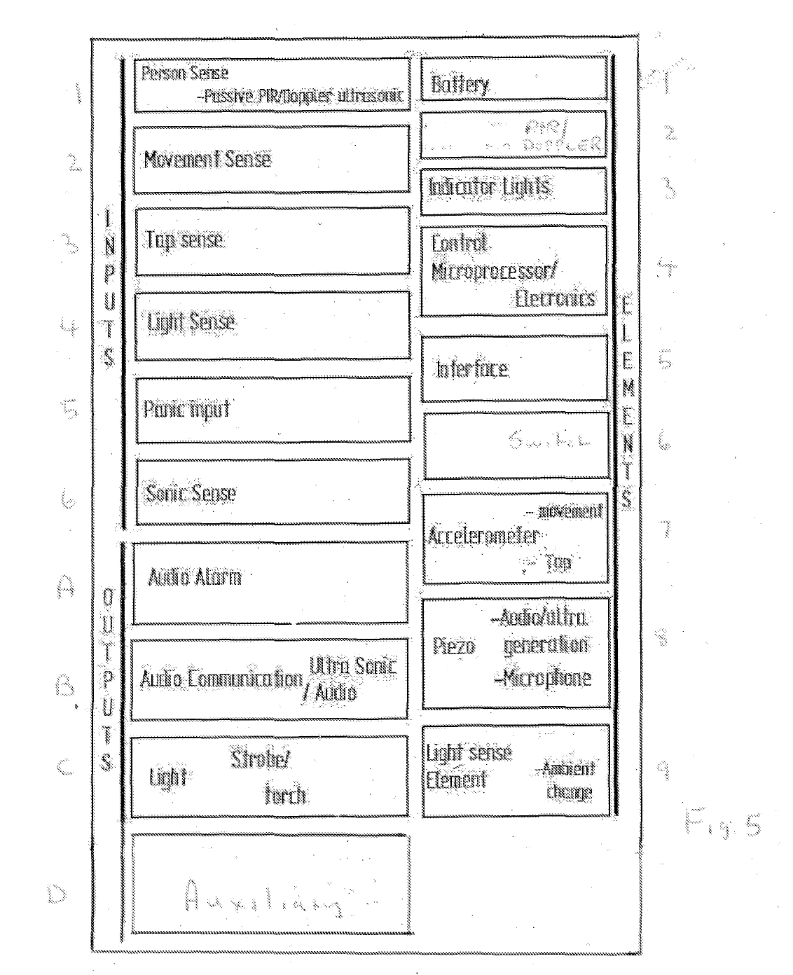

Turning now to FIG. 5, the column designated “inputs” indicates the various types of stimulation that are used to trigger an alarm condition. These, commencing at the top of the column, are:—
1. The sensing of the movement of a person in the vicinity of the alarm. This can be by means of a passive infrared detector or by means of the system referred to as “Ultrasonic Doppler” and which is typically used in car alarms.
2. The sensing of movement of the alarm itself using, for example, an accelerometer.
3. Detection by the alarm's movement sensor that the alarm is being tapped. A pre-stored sequence of taps can be stored in the memory of the alarm. When the alarm is tapped in the same sequence, the incoming taps are compared with the stored taps and if there is sufficient identity the alarm is armed or disarmed. The sensing of taps imparted to the casing in a specific sequence and/or from different faces of the casing can also be used to change the parameters of the mode into which the alarm device has been switched. Using three faces of the casing which are at right angles to one another means that the forces exerted by tapping are along the x, y and z axes.
4. The sensing of a change in the lighting level to which the alarm is subjected. This enables closed items which do not permit light to enter to be protected.
5. The sensing of a panic input by way of the switch 32 mounted on the casing.
6. The sensing of a received sound having predetermined characteristics.

When triggered, the alarm is capable of establishing the following conditions, as listed on the left hand side of FIG. 5 under the heading “Outputs”:—
A. A loud audible alarm which is emitted from the piezo electric sounders.
B. A sound signal at audible or ultrasonic wave lengths and which is detected by other devices as will be described below.
C. A strobe light, constituted by the LED or LEDS behind the lens part 30, which is of sufficient power to impair the vision of a person into whose eyes the light is directed. On a lower power setting, and continuously on, the strobe light can function as a torch.
D. Activation of an auxiliary device powered through the connections 36 as will be described below.

The right hand column sets out the components that are required to enable the alarm to function as described above:—
1 A battery, or set of batteries and, if desired, a charging circuit for a rechargable battery or batteries if the battery life of non-rechargeable batteries is deemed to be unacceptably short.
2 An element sensitive to the movement of a person in the vicinity of the alarm such as a PIR (passive infrared) or an “ultrasonic Doppler”.
3 The indicator lights 20, 22, 24, 26 and 28 for indicating to the user the current condition of the device. For example, the lights can indicate the state of charge of the battery, the status of the alarm, that is, on or off and if on which alarm mode is activated, the sensitivity setting of the alarm mode which is activated etc.
4 A microprocessor for controlling the electronics of the alarm.
5 At the rear of the casing there are four electrical connections 36 which constitute an interface. These enable auxiliary equipment such as a radio frequency based communications module (GSM, Bluetooth, etc), an external battery charger, a strobe light, a high voltage taser, a pepper spray or a camera to be attached.
6 Activation of the switch 30 can be used to control a number of the alarm device's functions. This will be described below. Its main functions are to bring the alarm device out of sleep mode, to put it into sleep mode and to act as a panic button when it is this mode that has been selected. Means are provided for detecting a panic signal caused by activating the switch 32 and for triggering the sounders 12 and 14 and/or the strobe light and/or the communication signal referred to under B above. To avoid false alarms, two or more activations of the switch 32 can be required to institute a panic alarm. Alternatively, the device can be such that only one activation of the switch 32 is required but this has to be followed by an impact before the panic alarm state is established. Knocking the device on a hard surface or dropping it can provide necessary impact.
7 An accelerometer, or equivalent means, that is sensitive to any movement of the alarm device and to the device being tapped.
8 The piezo electric sounders and means for driving the sounders usable for a purpose to be described. The piezo electric sounders can be used as microphones or a separate microphone can be provided.
9 An ambient light sensor.

Two possible methods of operating the alarm device will now be described by way of example. According to the first method activating the switch 32 a different number of times is used to set the alarm's mode. Captions next to the LEDS 20, 22, 24, 26, 28 indicate the mode that the alarm device is in. For example, if the alarm device is to be stowed into a dark, closed compartment, the appropriate number of depressions of the push button switch 32 will cause the LED next to a caption reading, say, “light activation mode” to illuminate. A bleeping sound will indicate that in a predetermined number of seconds the alarm will become active and must be stowed before the end of that time. By tapping the before it starts bleeping the sensitivity of the light sensor can be varied. A visual indication of the sensitivity setting can be obtained by causing the illuminated LED to flash at a faster or slower rate. When removed from the dark space the alarm device will again bleep to warn an authorized user to tap the alarm device in the requisite sequence to prevent it going to its alarm state.

In an alternative form selecting the mode to be used can be achieved by tapping the device instead of using the switch 32. In this form the switch 32 is only used to bring the alarm out of sleep mode, to put it into sleep mode and as a panic button. Other changes in status are brought about by tapping the alarm as described above.

During the period before the alarm device starts bleeping to indicate it is arming a parameter of the selected mode can be changed by tapping the alarm device. To ensure that the necessary range of input signals is possible, the accelerometer or the like can be sensitive to taps on different parts of the casing such as on opposite main faces or opposite ends and to different numbers of taps.

It is possible to use the sound signal emitted by the sounders whether at audible or ultrasonic wave lengths, to trigger one or more like devices so that it is not just a single alarm that is activated but two or more. In this way an alarm situation established at one device can be caused to cascade throughout an area under protection, meaning an area where such devices are distributed. To reduce the possibility of false alarms it is preferred that the signal be a complex multiplexed signal.

It will be understood that communication between devices can be used to arm, disarm and establish alarm conditions in a group of devices when one is armed or disarmed or goes into a alarm condition.

It is also possible to connect a sound sensitive device into the circuit of a fixed alarm installation in much the same way as the panic buttons are normally connected in. This means that the alarm installation is always “on” insofar as its ability to react to an alarm sound generated by a device according to the present invention is concerned. The signal which triggers the fixed alarm installation and causes a signal to be transmitted to the control centre of the service provider is preferably in the ultrasonic range.

It will be understood that it is also possible to use repeaters to ensure that an alarm signal from one device reaches another device which can itself emit an audible sound or a visible alarm warning such as a strobe light. It is envisaged that an alarm device protecting an area could, when triggered, activate either directly or by way of repeaters, another device which could be positioned outside the area being protected and where its sound or light signal would be more likely to be heard or seen.

It is also possible for other security devices such as smoke detectors, gas detectors and heat detectors to have the ability to communicate with a device in accordance with the present invention. Most detectors which are not connected into a fixed installation merely emit a relatively low volume sound. By emitting a sound that is detected by a device in accordance with the present invention, the alarm condition can be transferred, as described, to a more prominent location which enhances the prospects of the alarm condition being detected early.

It will be further understood that the nature of the portable alarm is such that, after the alarm mode has been chosen and set, there has to be a delay before the alarm is armed so that it can be placed or stowed depending on the mode chosen. Similarly if the alarm is triggered after being armed, there must be a delay before the device actually commences sending its alarm signal. This delay later gives the authorized user time to intervene and disarm the device thereby to prevent the alarm device going to its alarm mode and transmitting its alarm signal.

It is also possible to use the switch 32 as the primary command input device instead of tapping the casing. In this form a sequence of switch operations is used to set the device into the desired mode.

The sequence can be as follows:

The user first enters the code which is going to be needed later to deactivate the device. This is done by a series of switch operations with short pauses between each sequence. For example to set the code 1, 2, 1, 1 the sequence is one switch operation; pause; two switch operations; pause; one switch operation; pause; one switch operation.

The code entered is confirmed by a series of light flashes. In this example, flash: pause; flash/flash; pause: flash: pause: flash. One of the LEDS can be used for this purpose or different LEDS can flash.

One or more of the LEDS then illuminate briefly to form a bar graph which indicates battery status.

Next the five LEDS illuminate in sequence. Illumination of each LED indicates that a particular mode is available for selection. The five modes indicated by single illuminations are:

Passive infrared detector activation possible

Motion sensor activation possible

Light sensor activation possible

Torch activation

Panic activation

To obtain more modes, two LEDS can illuminate simultaneously.

If any of the first three modes is selected, the LEDS illuminate in turn to give the appearance of a sweeping light. When the requisite sensitivity is showing, the switch is depressed to select that sensitively and start a count down.

After a suitable time delay to enable the device to be stowed or placed where required, the device enters its “active” mode in which movement (either of the device or movement of a person in its vicinity or a change in light levels) will set it off.

When either of the last two modes is selected, the sensitivity adjustment stage is not required and no time delay is necessary. The torch can switch on immediately and the panic alarm can sound immediately. As explained above impact following switch operation can be made a prerequisite to the panic alarm sounding.

If the device is moved or there is a movement in its vicinity or the light level changes, the count down towards an alarm condition being established commences. By re-entering to code used during the arming procedure, the count down to the establishment of the alarm conditions is terminated.

It is possible, where an area is protected by more than one device, for all the devices to be activated simultaneously when a first device is placed into its active mode. This can be achieved by providing each device with an appropriate sound generator and sound receiver.

When an alarm condition is established, the sound and/or light can be transmitted for a predetermined period of time and then switched off. Unless the code is keyed in before expiry of a predetermined period of time after the sound and light were switched off, the light and sound start again. This can happen, say, two or three more times, before the device returns to sleep mode.

1. A portable alarm device including means for arming and disarming the device and means sensitive to movement of a person in the vicinity of the alarm device and/or means sensitive to movement of the portable alarm itself and/or means sensitive to tapping of the alarm device and/or means sensitive to changes in the ambient lighting level to which the alarm device is subjected.

2. A portable alarm device as claimed in claim 1 and including means which emit sound, or means which emit light, or means which emit both sound and light, when an alarm condition is established.

3. A portable alarm device as claimed in claim 1, and including a sound receiver for receiving a sound signal from another such device thereby to establish an alarm condition in said device whereby a series of two or more alarm devices can be triggered upon an alarm condition being established by one such device.

4. A device as claimed in claim 1 and including a manually operated switch for putting the device into sleep mode, bringing it out of sleep mode and acting as a panic button.

5. A device as claimed in claim 1 and including a switch and means for detecting a sequence of manual operations of said switch thereby to permit an arming code to be stored, which code, when re-entered, disarms the device.

6. A device as claimed in claim 5 and including scrolling means for permitting commands to be given to the different functions of the device in turn, and a plurality of light sources each of which when illuminated indicates that access to a specific function of the device is available at that time.

7. A device as claimed in claim 6, and including means for detecting changes in ambient lighting level, means for detecting movement of a person in the vicinity of the device, and means for detecting movement of the device itself, these functions being accessible in sequence for the purpose of giving commands.

8. A device as claimed in claim 1 and further including a torch.

9. (canceled)

10. A device as claimed in claim 4, and including means sensitive to an impact, means for detecting operation of said switch and for detecting an impact in succession and means activating said means for emitting sound or the means for emitting light or both such means upon such succession being detected.

11. A device as claimed in claim 1 and including means for transmitting a sound signal upon the device entering its activated state, and means for receiving such a sound signal from another device reception of which signal places the device in its activated state.

12. A portable alarm device as claimed in claim 2, and including a sound receiver for receiving a sound signal from another such device thereby to establish an alarm condition in said device whereby a series of two or more alarm devices can be triggered upon an alarm condition being established by one such device.

13. A device as claimed in claim 2 and including a switch and means for detecting a sequence of manual operations of said switch thereby to permit an arming code to be stored, which code, when re-entered, disarms the device.

14. A device as claimed in claim 3 and including a manually operated switch for putting the device into sleep mode, bringing it out of sleep mode and acting as a panic button.

15. A device as claimed in claim 2 and including a switch and means for detecting a sequence of manual operations of said switch thereby to permit an arming code to be stored, which code, when re-entered, disarms the device.

16. A device as claimed in claim 3 and including a switch and means for detecting a sequence of manual operations of said switch thereby to permit an arming code to be stored, which code, when re-entered, disarms the device.

17. A device as claimed in claim 2 and further including a torch.

18. A device as claimed in claim 3 and further including a torch.

19. A device as claimed in claim 4 and further including a torch.

20. A device as claimed in claim 5 and further including a torch.

21. A device as claimed in claim 6 and further including a torch.
